(19) United States
(12) Patent Application Publication
(10) Pub. No.: US 2023/0124540 A1
(43) Pub. Date: Apr. 20, 2023

(54) SPECIAL VEHICLE FOR EXTINGUISHING VEHICLE FIRE

(71) Applicant: JAE KYONG LIM, Ongjin-gun (KR)

(72) Inventor: JAE KYONG LIM, Ongjin-gun (KR)

(21) Appl. No.: 18/047,145

(22) Filed: Oct. 17, 2022

(30) Foreign Application Priority Data
Oct. 20, 2021 (KR) 10-2021-0140006
Jan. 18, 2022 (KR) 10-2022-0007010

(51) Int. Cl. A62C 3/07; A62C 27/00; B60P 3/12; B60P 3/07

(52) U.S. Cl. CPC A62C 3/07; A62C 27/00; B60P 3/122; B60P 3/07

(57) ABSTRACT

The present invention relates to a special vehicle for extinguishing a vehicle fire, comprising a seating unit 100 in which a driver is seated, a loading unit 200 disposed at a rear end of the seating unit and configured to load a vehicle on fire, and a transfer unit 300 configured to transfer the vehicle into the loading unit, in which an opening portion through which the vehicle is transferred is formed at a rear side of the loading unit 200, in which the transfer unit 300 is hingedly and rotatably coupled to a lower end of the opening portion, in which the transfer unit 300 serves as a ramp for transferring the vehicle into the loading unit when the opening portion is opened, and in which the transfer unit 300 serves to isolate the loading unit 200 when the opening portion is closed.

### CROSS-REFERENCE TO RELATED APPLICATIONS

This application claims the priority of Korean Patent Application No. 10-2021-0140006, filed on Oct. 20, 2021 and Korean Patent Application No. 10-2022-0007010 filed on Jan. 18, 2022, in the Korean Intellectual Property Office, the disclosure of which is incorporated herein by reference.

### BACKGROUND OF THE INVENTION

### Field of the Invention

The present invention relates to a special vehicle manufactured for special purposes and used for special purposes, and more particularly, to a special vehicle for extinguishing a vehicle fire, which is capable of extinguishing a vehicle fire in an isolated space while a vehicle is quickly isolated from a surrounding environment and moved when a fire occurs in a vehicle existing in a facility such as an underground parking lot.

### Description of the Related Art

A vehicle is equipped with a power generation unit, such as an engine, for moving a vehicle body, and the power generation unit has a risk of explosion and fire caused by impact or external ignition factors.

In particular, an electric vehicle, which has been developed recently and obtains a rotational force of a motor from a charged battery, a hydrogen vehicle, which obtains a rotational force of a motor while generating power by using hydrogen stored in a storage tank, or a hybrid thereof is environmental-friendly and produces less noise in comparison with an engine-powered vehicle in the related art. However, the risk of explosion or fire with respect to the battery for operating the electric vehicle or the hydrogen tank for operating the hydrogen vehicle further increases.

A lithium-ion battery is widely and mainly used for a battery for an electric vehicle because the lithium-ion battery has a very high energy density and is light in weight, but the lithium-ion battery has a drawback in that the lithium-ion battery is vulnerable to a high temperature and a fire. A solid state battery has a low likelihood of ignition, but still has a problem in that a fire is easily diffused once the fire occurs.

A hydrogen fuel cell vehicle is a type of fuel cell vehicle that operates by using hydrogen and a fuel cell, and the hydrogen fuel cell vehicle generates electric power by means of a chemical reaction between oxygen and compressed hydrogen and supplies power to an electric motor.

The hydrogen fuel cell vehicle produces electricity by means of an electrochemical reaction between hydrogen in a hydrogen storage tank and oxygen in air and operates a motor by using the produced electricity, thereby generating power.

The hydrogen fuel cell vehicle is a zero-emission vehicle that emits only water and heat as by-products, and the hydrogen fuel cell vehicle produces fewer contaminants and noise in comparison with an internal combustion engine vehicle.

The hydrogen fuel cell vehicle is advantageously an environmental-friendly, but when a fire occurs due to external impact or the like and a battery cell is on fire, the fire does not go out until the battery cell is entirely burnt down. Further, the fire is spread to the vehicle, which increases a likelihood that the vehicle is entirely burnt down.

Therefore, it is very important to initially extinguish a fire in the hydrogen fuel cell vehicle. Therefore, there is a need for a method capable of more quickly and effectively extinguishing a fire occurring in the hydrogen fuel cell vehicle.

[Documents of Related Art]

### PATENT DOCUMENTS

Korean Patent No. 10-2197265 (published on Dec. 31, 2020)
Korean Patent No. 10-2060921 (published on Dec. 30, 2019)

### SUMMARY OF THE INVENTION

An aspect of the present invention provides a special vehicle for extinguishing a vehicle fire, which includes a loading unit and a transfer unit that are capable of extinguishing a fire by quickly transferring and loading a vehicle on fire into an isolated space in the event of the fire in the vehicle (particularly, a hydrogen vehicle or an electric vehicle that has a high risk of fire).

An aspect of the present invention also provides a special vehicle for extinguishing a vehicle fire, in which a loading unit and a transfer unit each have a refractory thermal insulation structure to prevent flame and heat of a fire in a vehicle loaded into the loading unit from being transferred to the outside.

Other objects of the present invention may be achieved by the detailed description of the present invention described with reference to the accompanying drawings.

According to an aspect of the present invention, there is provided a special vehicle for extinguishing a vehicle fire, the special vehicle including: a seating unit 100 in which a driver is seated; a loading unit 200 disposed at a rear end of the seating unit and configured to load a vehicle on fire; and a transfer unit 300 configured to transfer the vehicle into the loading unit, in which an opening portion through which the vehicle is transferred is formed at a rear side of the loading unit 200, in which the transfer unit 300 is hingedly and rotatably coupled to a lower end of the opening portion, in which the transfer unit 300 serves as a ramp for transferring the vehicle into the loading unit when the opening portion is opened, and in which the transfer unit 300 serves to isolate the loading unit 200 when the opening portion is closed.

In addition, the special vehicle may further include an opening/closing device configured to forcibly open or close the transfer unit 300.

According to the present invention, one end of the opening/closing device may be rotatably connected to one side wall or two opposite side walls of the loading unit 200, the other end of the opening/closing device may be rotatably connected to one side or two opposite sides of the transfer unit 300, and the opening/closing device may have a body having a length that is forcibly increased or decreased by a user's manipulation.

According to the present invention, the special vehicle may further include a penetration blade 400 provided at an end of the transfer unit 300 and configured to facilitate penetration into a contact surface of a wheel of the vehicle.

According to the present invention, the loading unit 200 and the transfer unit 300 may each have a three-layer structure including an inner wall, a refractory thermal insulation material, and an outer wall.

According to the present invention, the penetration blade may include: a penetration portion having a blade at one side thereof; and a weight portion provided at a side opposite to the penetration portion based on a rotary shaft, having a weight proportional to a weight of the penetration portion, and configured to force the penetration portion to be inclined toward the opposite side to the rotary shaft.

According to the present invention, the special vehicle may further include: a sprinkler provided on a roof of the loading unit 200 and configured to supply firefighting water into the loading unit; and a battery fluid storage groove provided in a bottom surface of the loading unit 200 and configured to store a battery fluid leaking from the vehicle.

According to the special vehicle for extinguishing a vehicle fire according to the present invention as described above, the penetration blade is formed to enter the contact surface of the wheel of the vehicle, such that the vehicle on fire may be forcibly transferred into the loading unit. The loading unit and the transfer unit each made of a refractory thermal insulation material are provided to block flame and high-temperature heat of the vehicle on fire, which are transferred and loaded into the loading unit, from the outside, such that the vehicle on fire may be safely isolated, and a subsequent action such as an operation of extinguishing the fire on the vehicle may be simultaneously performed, which makes it possible to prevent primary and secondary damage caused by the vehicle on fire.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is an overall perspective view of a special vehicle for extinguishing a vehicle fire according to one embodiment of the present invention;

FIG. 2 is a perspective view illustrating a state in which a transfer unit in FIG. 1 is fully unfolded and opened;

FIG. 3A and FIG. 3B are views for explaining a configuration and operation of a transfer unit and a penetration blade of a special vehicle for extinguishing a vehicle fire according to another embodiment of the present invention; and

FIG. 4 is a side configuration view illustrating a state in which a catching unit 500 for preventing a rearward movement of a vehicle is further provided on a loading unit 200 of a special vehicle for extinguishing a vehicle fire according to a still another embodiment of the present invention.

### DETAILED DESCRIPTION OF THE PREFERRED EMBODIMENT

In order to sufficiently understand the present invention, advantages in operation and function of the present invention, and the object to be achieved by carrying out the present invention, reference needs to be made to the accompanying drawings for illustrating an exemplary embodiment of the present invention and contents disclosed in the accompanying drawings.

Hereinafter, the present invention will be described in detail by describing the embodiments of the present invention with reference to the accompanying drawings. Like reference numerals indicated in the respective drawings may refer to like members.

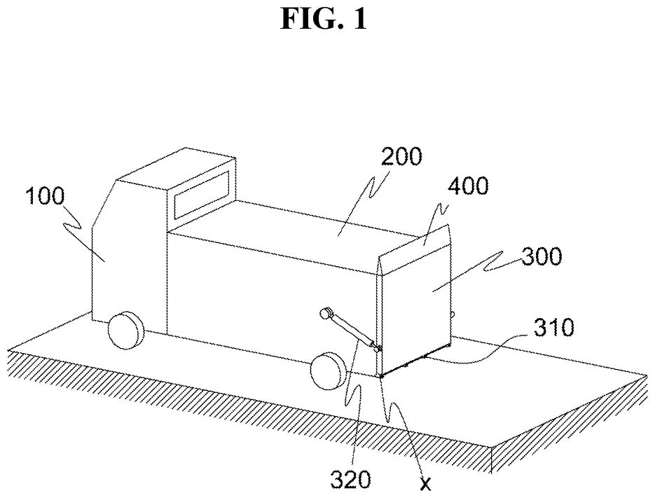

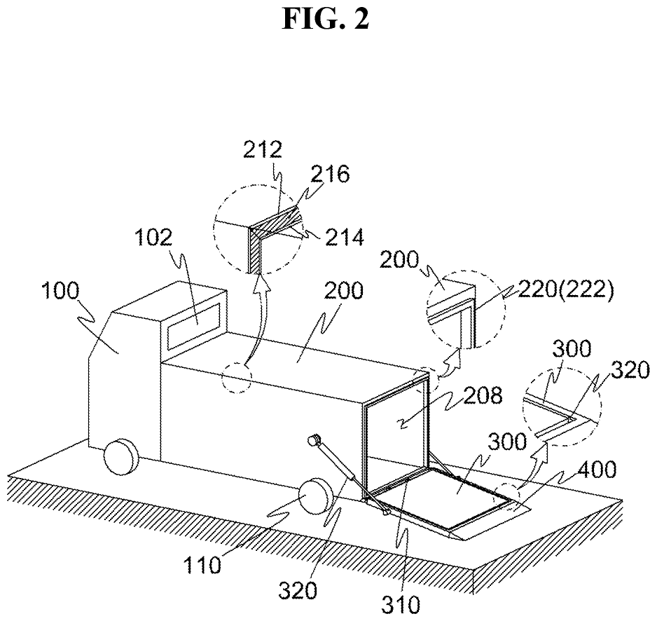

FIG. 1 is an overall perspective view of a special vehicle for extinguishing a vehicle fire according to one embodiment of the present invention, and FIG. 2 is a perspective view illustrating a state in which a transfer unit in FIG. 1 is fully unfolded and opened. Referring to FIGS. 1 and 2, a special vehicle for extinguishing a vehicle fire according to the present invention includes a seating unit 100, a loading unit 200, and a transfer unit 300.

The seating unit 100 provides a space in which a driver is seated and drives and manipulates the vehicle. Walls or windows 102, which constitute the seating unit 100, each have a refractory thermal insulation structure to ensure safety of the driver. The seating unit 100 may be configured to prevent flame or heat from entering the seating unit 100 when a vehicle on fire enters a region of fire (i.e., a comparatively wide fire region in which flame surrounds a peripheral space including the vehicle as the fire spread to the periphery from the fire on the vehicle). Further, the emergency rescue equipment such as an oxygen supplier is provided in the seating unit 100 to maintain safety of the driver until the special vehicle moves to a safe position from a dangerous fire, which makes it possible to perform an overall process of transferring the vehicle on fire and extinguishing the fire.

In this case, the window 102 of the loading unit 200 is a transparent window through which the driver observes, from the seating unit 100, a rear side where the vehicle is present. The window 102 may be made of refractory glass.

The loading unit 200 is installed at a rear end of the seating unit 100 and provides a loading space for loading the vehicle on fire. An opening portion 208 is formed at a rear side of the loading unit 200 to transfer the vehicle and provides a horizontal passageway so that the vehicle on fire enters the loading space. In addition, the loading unit 200 typically has a box-shaped structure having a quadrangular cross-section and needs to have a sufficient space for loading the vehicle. The loading unit 200 has an isolation vacuum system to quickly and initially extinguish the fire. The loading unit 200 has a horizontal deviation on a bottom surface to store various types of contaminants (solutions) that may leak from the vehicle on fire (a battery or the like).

The transfer unit 300 is an element for transferring the vehicle into the loading unit 200. The transfer unit 300 simultaneously performs a function of transferring the vehicle and an isolation function for isolating the loading unit from the outside. The vehicle on fire loaded into the loading space of the loading unit 200 is blocked from the outside air, and no oxygen is introduced into the loading space of the loading unit 200, such that the fire may be slowly extinguished. Further, a fire extinguisher is installed in the loading unit 300 to actively extinguish the fire.

In addition, the isolation configuration between the transfer unit and the loading unit of the present invention includes a water-tight structure that forcibly extinguishes the firer on the vehicle by using water. To this end, a water tank (not illustrated) may be provided at an upper end of the loading unit 200, and water for extinguishing the fire may be sprayed into the loading unit. Only a supply valve for supplying water into the loading unit is installed at one end of the loading unit without installing the water tank on the loading unit in consideration of a weight of the special vehicle. In this case, the special vehicle may move to a place where water may be supplied to the special vehicle, and then water for extinguishing the fire may be supplied and sprayed into the loading unit through the supply valve.

Meanwhile, the transfer unit 300 is hingedly and rotatably coupled by means of a hinge device 310 provided at a lower end of the opening portion, such that the transfer unit 300 hingedly rotates upward or downward about a hinge shaft of the hinge device 310. A plurality of hinge devices 310 may be installed side by side to stably maintain the hinged rotation of the transfer unit 300.

Therefore, when the opening portion 208 of the loading unit 200 is fully opened, the transfer unit 300 performs the transfer function while serving as a ramp for transferring the vehicle into the loading space in the loading unit 200. When the transfer unit 300 is lifted up and the opening portion 208 is completely closed, the transfer unit 300 performs the isolation function of isolating the loading unit 200 and defining an isolated space.

In addition, referring to FIG. 2, the present invention may further include an isolation structure for reinforcing the isolation between the loading unit 200 and the transfer unit 300. The isolation structure may include a protruding portion 220 protruding from an end of the loading unit 200, and a concave portion 320 of the transfer unit 300 that is formed to correspond to the protruding portion 220. Therefore, when the transfer unit 300 is lifted up and the opening portion 208 of the loading unit 200 is closed, the protruding portion 200 of the loading unit 200 is inserted into the concave portion 320 of the transfer unit 300, thereby achieving complete isolation. A non-flammable gasket 222 is installed on the protruding portion 200, such that the isolation structure may be maintained as it is even though heat is transmitted from the flame.

In addition, as illustrated, the present invention may further include an opening/closing device 320 for forcibly opening or closing the transfer unit 300 by the user (driver). The opening/closing device 320 may have a typical cylindrical body having a length that is forcibly increased or decreased by the user's manipulation. Further, one end of the opening/closing device 320 is rotatably connected to one side wall or two opposite side walls of the loading unit 200, and the other end of the opening/closing device 320 is rotatably connected to one side or two opposite sides of the transfer unit 300.

The drawings illustrate the cylindrical shape as an example of a shape of the opening/closing device 320, but the present invention is not limited thereto. For example, other various shapes, such as a lifting configuration using a winding roller, capable of rotating and lifting up the transfer unit 300 may also be included in the opening/closing device according to present invention.

An operating device may be provided in the seating unit 100 so that the driver seated in the seating unit 100 may immediately and easily manipulate the opening/closing device 320 at a desired time.

In addition, as illustrated, the present invention may further include a penetration blade 400 provided at an end of the transfer unit 300 and configured to facilitate penetration to contact surfaces of wheels of the vehicle. Therefore, the penetration blade 400 may easily enter bottom contact surfaces of the wheels of the vehicle on fire. Typically, a fire occurs in a vehicle in a parked state (braked state). Therefore, when the penetration blade 400 enters a lower side of the vehicle, a stopped state of the vehicle is maintained, such that the penetration blade 400 may enter the lower side of the vehicle on fire. In addition, typically, a vehicle is parked adjacent to a wall of a parking space of an underground parking space in a building. Therefore, the penetration blade may enter the contact surfaces of the wheels in a state in which the vehicle on fire is pushed toward the wall and brought into contact with the wall.

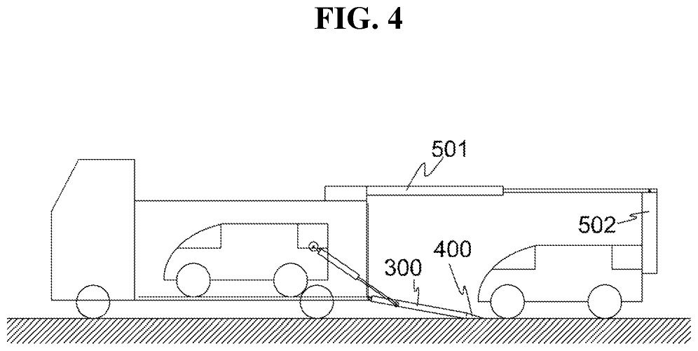

However, in case that the vehicle on fire is not braked or the vehicle on fire is present at a position distant from the wall of the parking space, the vehicle on fire cannot be transferred into the loading unit when the vehicle on fire slips in a rearward direction while the special vehicle according to the present invention moves rearward and pushes the penetration blade. To solve the above-mentioned problem, the loading unit 200 according to the present invention may further include a catching unit 500 for preventing a rearward movement of the vehicle, as illustrated in FIG. 4.

The catching unit 500 for preventing a rearward movement of the vehicle may include a retractable rod 501 such as a cylinder configured to be retracted by the driver, and a catching protrusion 502 provided at an end of the retractable rod 501 and configured to catch an opposite portion of the vehicle on fire. That is, when the special vehicle according to the present invention moves rearward toward the vehicle on fire in a state in which the retractable rod 501 is extended and the catching protrusion 502 catches the opposite portion of the vehicle on fire, the retractable rod 501 is retracted by a distance that the special vehicle moves rearward. This process needs to be maintained until the penetration blade 400 enters the bottom contact surfaces of the two front and rear wheels of the vehicle on fire.

In addition, referring to FIG. 2, in the present invention, the loading unit 200 and the transfer unit 300 may each have a three-layer structure including an inner wall 214, a refractory thermal insulation material 216, and an outer wall 212. The inner wall 214 and the outer wall 212 may each be made of a metallic material, particularly, stainless steel (STS). A cement board, which is generally used as a non-flammable finishing material, or a ceramic board, which is a thermal insulation material provided in other forms, may be selected as the refractory thermal insulation material 216.

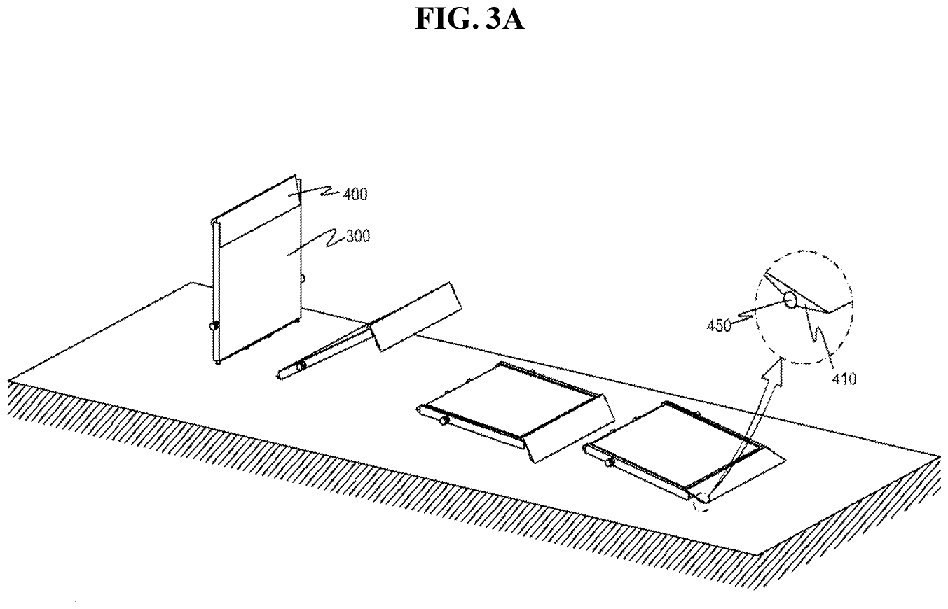

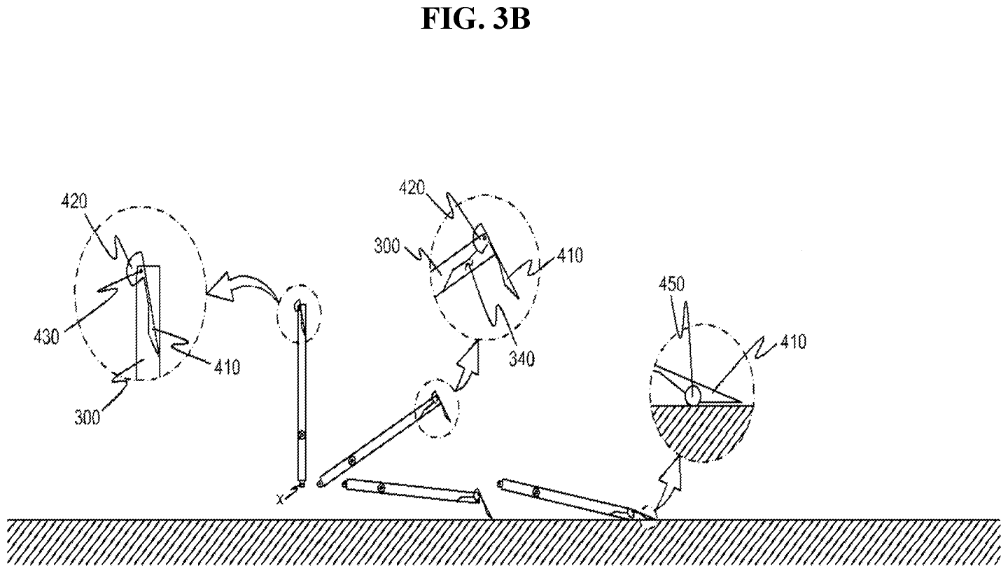

FIG. 3A and FIG. 3B are views for explaining a configuration and operation of the transfer unit and the penetration blade of the special vehicle for extinguishing a vehicle fire according to another embodiment of the present invention. Referring to FIG. 3A and FIG. 3B, in the present invention, the penetration blade 400 may include a penetration portion 410 having a blade at one side thereof, and a weight portion 420 provided at a side opposite to the penetration portion 410 based on a rotary shaft 430, having a weight proportional to a weight of the penetration portion 410, and configured to force the penetration portion 410 to be inclined toward the opposite side to the rotary shaft 430.

Therefore, the penetration portion 410 of the penetration blade is in a state of being inclined in a direction toward the outside of the special vehicle at a point in time at which the transfer unit 300 rotates about the hinge shaft x and comes into contact with the ground surface while being unfolded on the ground surface. Therefore, when the transfer unit 300 further moves downward, the penetration blade may be naturally unfolded along the ground surface.

Meanwhile, a blade accommodation portion 340 may be provided at an end of the transfer unit 300 and accommodate the penetration portion 410 therein in a state in which the transfer unit 300 is vertically folded. Furthermore, a sliding wheel 450 may be further installed on a lower surface of the penetration portion 410 and smoothly guide a forward motion of the penetration portion 410.

Meanwhile, wheel units 110 may be connected to the power transmission unit of the special vehicle according to the present invention and transmit driving power of the vehicle to the ground surface. A wheel having a comparatively small diameter may be selected as the wheel unit 110 to reduce a height of the loading unit, which makes it easy to load and transfer the vehicle on fire.

In addition, the present invention may include a sprinkler (not illustrated) provided on a roof of the loading unit 200 and configured to supply firefighting water into the loading unit to extinguish the fire on the vehicle. A battery fluid storage groove may be further formed in a bottom surface of the loading unit 200 and store a battery fluid leaking from the vehicle, thereby preventing the battery fluid from leaking to the outside.

While the exemplary embodiments of the present invention have been illustrated and described above, the present invention is not limited to the specific exemplary embodiments, and various modifications can of course be made by those skilled in the art to which the present invention pertains without departing from the subject matter of the present invention as claimed in the claims. In addition, the contents, which can be easily inferred from the accompanying drawings, should be interpreted as being included in the contents of the present invention even though the contents are not disclosed in the detailed description. Various modifications should not be understood individually from the technical spirit or prospects of the present invention.

What is claimed is:

1. A special vehicle for extinguishing a vehicle fire, the special vehicle comprising:
a seating unit 100 in which a driver is seated;
a loading unit 200 disposed at a rear end of the seating unit and configured to load a vehicle on fire; and
a transfer unit 300 configured to transfer the vehicle into the loading unit,
wherein an opening portion through which the vehicle is transferred is formed at a rear side of the loading unit 200,
wherein the transfer unit 300 is hingedly and rotatably coupled to a lower end of the opening portion,
wherein the transfer unit 300 serves as a ramp for transferring the vehicle into the loading unit when the opening portion is opened, and
wherein the transfer unit 300 serves to isolate the loading unit 200 when the opening portion is closed.

2. The special vehicle of claim 1, further comprising:
an opening/closing device configured to forcibly open or close the transfer unit 300.

3. The special vehicle of claim 2, wherein one end of the opening/closing device is rotatably connected to one side wall or two opposite side walls of the loading unit 200,
wherein the other end of the opening/closing device is rotatably connected to one side or two opposite sides of the transfer unit 300, and
wherein the opening/closing device has a body having a length that is forcibly increased or decreased by a user's manipulation.

4. The special vehicle of claim 1, further comprising:
a penetration blade 400 provided at an end of the transfer unit 300 and configured to facilitate penetration into a contact surface of a wheel of the vehicle.

5. The special vehicle of claim 1, wherein the loading unit 200 and the transfer unit 300 each have a three-layer structure including an inner wall, a refractory thermal insulation material, and an outer wall.

6. The special vehicle of claim 4, wherein the penetration blade comprises:
a penetration portion having a blade at one side thereof; and
a weight portion provided at a side opposite to the penetration portion based on a rotary shaft, having a weight proportional to a weight of the penetration portion, and configured to force the penetration portion to be inclined toward the opposite side to the rotary shaft.

7. The special vehicle of claim 1, further comprising:
a sprinkler provided on a roof of the loading unit 200 and configured to supply firefighting water into the loading unit; and
a battery fluid storage groove provided in a bottom surface of the loading unit 200 and configured to store a battery fluid leaking from the vehicle.
